(19) United States
(12) Patent Application Publication
(10) Pub. No.: US 2006/0142887 A1
(43) Pub. Date: Jun. 29, 2006

(54) Systems and methods for managing lot aggregation

(75) Inventors: Chi-Ren Huang, Banchiau City (TW); Shui-Tien Lin, Kinmen Hsien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Taiwan Semiconductor Manufacturing Co., Ltd.

(21) Appl. No.: 11/020,719

(22) Filed: Dec. 23, 2004

(51) Int. Cl. G06F 19/00

(52) U.S. Cl. 700/100; 700/103

(57) ABSTRACT

A system for managing lot aggregation. An interface receives a lot aggregation rule. A storage device stores first lot manufacture information and the lot aggregation rule. A processor integrates the lot aggregation rule into the first lot manufacture information to generate second lot manufacture information.

### BACKGROUND

The invention relates generally to manufacture control, and more particularly to controlling lot aggregation in a manufacturing environment.

For manufacturers that produce to order, such as most semiconductor manufacturers, order production is typically initiated with an intact lot comprising up to 25 wafers. As order production proceeds, wafers originally loaded in the intact lot may be put into other lots, such that the original lot is segregated into several parts. The lot segregation may bring about several disadvantages. For example, for an intact lot A divided into 5 parts, A1˜A5, during processing, all parts undergo wet etching separately, and each may be etched to different extent due to factors such as decay of etching solution. This processing non-uniformity can give rise to quality issues. When parts A1˜A5 undergo testing, such as a yield test or wafer acceptance test (WAT), results thereof are generated and transmitted to corresponding customers separately, who must then re-integrate them to obtain a complete test result. When parts A1˜A5 are ready for shipping, they may be conveyed in separate deliveries, requiring additional effort for the customer to receive and manage the entire batch.

### SUMMARY

In embodiments of a system for managing lot aggregation, comprising an interface, storage device, and processor, the interface receives a lot aggregation rule. The storage device stores first lot manufacture information and the lot aggregation rule. The processor integrates the lot aggregation rule into the first lot manufacture information to generate second lot manufacture information.

In embodiments of a method of managing lot aggregation, a lot aggregation rule is provided, specifying aggregation setting for a particular lot. Lot manufacture information is provided, comprising lot information and a corresponding processing schedule, and/or dispatch rule. The lot aggregation rule is integrated into the first lot manufacture information to generate second lot manufacture information.

The method may take the form of program code embodied in a tangible media. When the program code is loaded into and executed by a machine, the machine becomes an apparatus for practicing the method.

### DESCRIPTION OF THE DRAWINGS

The invention can be more fully understood by reading the subsequent detailed description and examples with references made to the accompanying drawings, wherein:

FIG. 1 is a schematic view of an embodiment of a manufacturing system implementing lot aggregation management; and

FIG. 2 is a flowchart of an embodiment of a lot aggregation management method.

### DETAILED DESCRIPTION

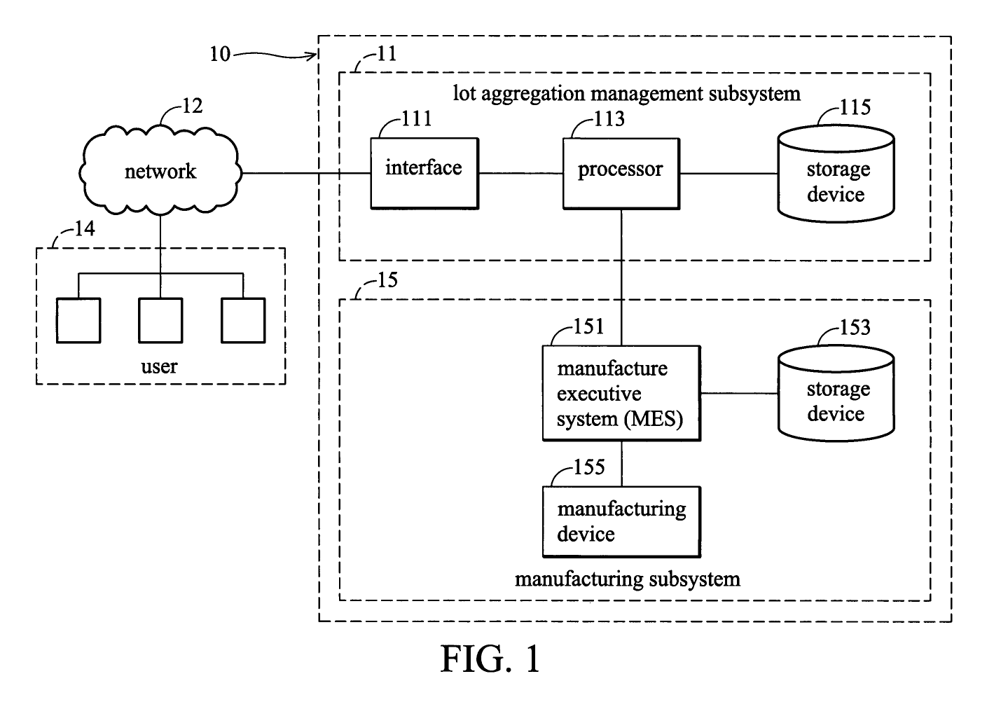

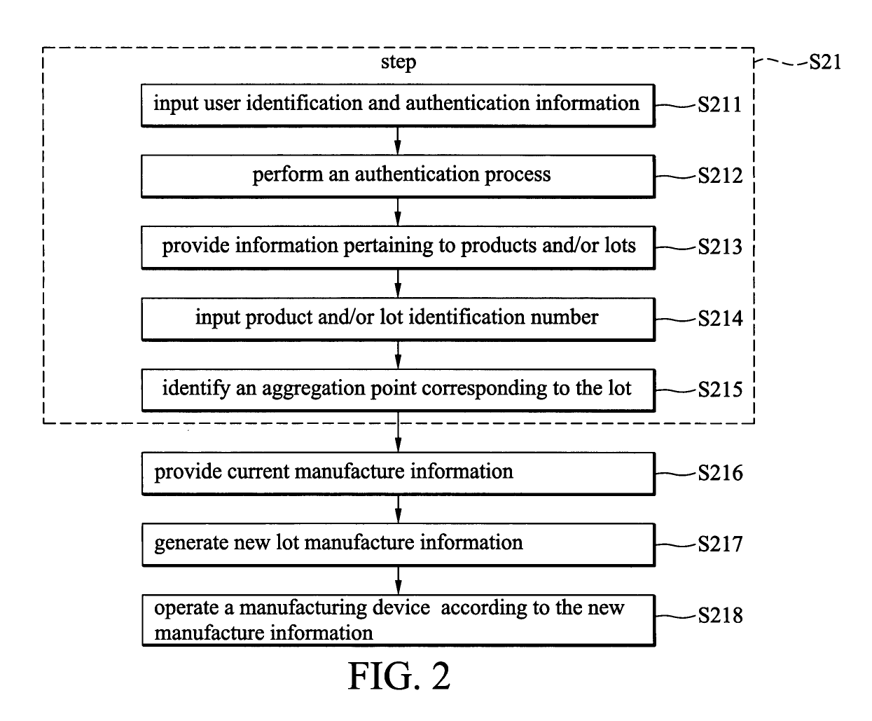

Exemplary embodiments of the invention will now be described with reference to FIGS. 1 and 2, which generally relate to lot aggregation management in a manufacturing environment. While some embodiments of the invention are applied with semiconductor manufacturing, it is understood that the product processed by the manufacturing system is not critical, and other manufacturing systems involving workpiece lot partition may be readily substituted.

In the following detailed description, reference is made to the accompanying drawings which form a part hereof, and in which is shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense. The leading digit(s) of reference numbers appearing in the Figures corresponds to the Figure number, with the exception that the same reference number is used throughout to refer to an identical component which appears in multiple Figures.

FIG. 1 is a schematic view of an embodiment of a manufacturing system implementing lot aggregation management. Specifically, a system 10 comprises a lot aggregation management subsystem 11 and manufacturing subsystem 15. The lot aggregation management subsystem 11 comprises an interface 111, processor 113, and storage device 115. The interface receives a lot aggregation rule through a network 12 from a user 14. The lot aggregation rule comprises identification information identifying a customer, product, and lot, and an aggregation setting comprising an aggregation step and/or stage corresponding to the lot. The storage device stores the received lot aggregation rule. The processor integrates the lot aggregation rule into first lot manufacture information to generate second lot manufacture information. The first manufacture information may be retrieved from a manufacture executive system (MES) 151 of the manufacturing subsystem 15, and the second manufacture information is transmitted thereto. The first and second manufacture information may comprise work-in-process information, processing stage information corresponding to a product and/or lot, processing schedule, and lot dispatch rule. The first and second manufacture information may be stored in a storage device 153, directing operation of a manufacturing device 155. When the second manufacture information is received, the first manufacture information is renewed accordingly, and the manufacturing device 155 operates according to the second manufacture information.

The processing algorithm implemented in processor 113 is detailed in the flowchart of FIG. 2.

In step S21, a lot aggregation rule is received. User identification and authentication information is input (step S211). The user identification and authentication information can be provided by a user, transmitted through the Internet, received by an interface, and relayed to a processor. An authentication process confirms user identity according to a corresponding identity document (step S212). Information pertaining to products and/or lots corresponding to the user identification information is provided (step S213). A product and/or lot identification number is input to identify a selected lot of a product (step S214). An aggregation setting is determined, identifying an aggregation point corresponding to the lot (step S215). The identification information of the user, product, lot, and the aggregation setting are referred to as a lot aggregation rule as a whole.

Current manufacture information pertaining to the lot is provided (step S216). The manufacture information comprises work-in-process information, product information, processing schedule, and lot dispatch rule, wherein the product information comprises processing stage information corresponding to a product and/or lot, and the work-in-process information comprises the identification information of a work-in-process.

The lot aggregation rule is incorporated into the current lot manufacture information to generate new lot manufacture information (step S217). The new manufacture information comprises counterpart contents corresponding to the current manufacture information. Specifically, the new manufacture information comprises a manufacture schedule and lot dispatch rule rearranging product flows enabling partitioned lots to be gradually reunited into one lot.

A manufacturing device operates according to the new manufacture information (step S218).

Various embodiments, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. Some embodiments may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing embodiments of the invention. When implemented on a general-purpose processor, the program code combines with the processor to provide a unique apparatus that operates analogously to specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

1. A system for managing lot aggregation, comprising:
an interface receiving a lot aggregation rule;
a storage device storing first lot manufacture information and the lot aggregation rule, wherein the lot aggregation rule comprises an aggregation setting and identification information, and the first lot manufacture information is retrieved from a manufacture executive system; and
a processor integrating the lot aggregation rule into the first lot manufacture information to generate second lot manufacture information, wherein the second manufacture information is transmitted to the manufacture executive system to renew the first lot manufacture information and to rejoin lots separated during manufacturing.

2. The system of claim 1, wherein the lot aggregation rule comprises identification information identifying a customer, product, and lot.

3. The system of claim 2, wherein the first and second lot manufacture information comprises work-in-process information comprising identification information of a work-in-process corresponding to the lot.

4. The system of claim 2, wherein the aggregation setting comprises an aggregation step and/or stage corresponding to the lot.

5. The system of claim 1, wherein the first and second lot manufacture information comprises product information comprising processing stage information corresponding to a product and/or lot.

6. The system of claim 1, wherein the first and second lot manufacture information comprises a processing schedule, respectively.

7. The system of claim 1, wherein the first and second lot manufacture information comprises a lot dispatch rule, respectively.

8. The system of claim 1, further comprising a manufacture executive system controlling processing of lots according to the second lot manufacture information.

9. A method of managing lot aggregation, comprising:
receiving a lot aggregation rule, wherein the lot aggregation rule comprises an aggregation setting and identification information;
providing first lot manufacture information, wherein the first lot manufacture information is retrieved from a manufacture executive system; and
integrating the lot aggregation rule into the first lot manufacture information to generate second lot manufacture information, wherein the second manufacture information is transmitted to the manufacture executive system to renew the first lot manufacture information and to rejoin lots separated during manufacturing.

10. The method of claim 9, wherein the lot aggregation rule comprises identification information identifying a customer, product, and lot.

11. The method of claim 10, wherein the first and second lot manufacture information comprises work-in-process information comprising identification information of a work-in-process corresponding to the lot.

12. The method of claim 10, wherein the aggregation setting identifies an aggregation point corresponding to the identification information of the work-in-process.

13. The method of claim 12, wherein the aggregation setting identifies an aggregation step or stage.

14. The method of claim 9, wherein the first and second lot manufacture information comprises product information comprising processing stage information corresponding to a product and/or lot.

15. The method of claim 9, wherein the first and second lot manufacture information comprises a processing schedule, respectively.

16. The method of claim 9, wherein the first and second lot manufacture information comprises a lot dispatch rule, respectively.

17. The method of claim 9, further comprising controlling processing of lots according to the second lot manufacture information.
